(19) United States
(12) Patent Application Publication
(10) Pub. No.: US 2015/0129722 A1
(43) Pub. Date: May 14, 2015

(54) OUTLET COVER WALL DOCK

(71) Applicant: Philip GREEN, Brooklyn, NY (US)

(72) Inventor: Philip GREEN, Brooklyn, NY (US)

(21) Appl. No.: 14/532,193

(22) Filed: Nov. 4, 2014

Related U.S. Application Data
(60) Provisional application No. 61/900,192, filed on Nov. 5, 2013.

(51) Int. Cl. H02J 7/00; F16M 13/02

(52) U.S. Cl. CPC H02J 7/0044; F16M 13/02
USPC 248/51

(57) ABSTRACT

An outlet cover comprising a face plate 6 with at least one outlet opening to fit over an electrical wall outlet; and a flat ledge 1 above and perpendicular to the outlet opening, wherein the ledge 1 has an opening 3, such that a mobile device and/or tablet fits securely on the ledge and the charging wire for the device and/or tablet fits through the opening 3 to charge the device and/or tablet without excess wire hanging.

This application claims the benefit of U.S. provisional application No. 61/900,192 filed Nov. 5, 2014, which is incorporated herein in its entirety by reference.

### FIELD OF THE INVENTION

The present invention relates to an outlet cover to hold a mobile device or computer tablet. More particularly, the invention is a wall dock charging station with a ledge to hold the mobile device or computer tablet securely in place while the device or tablet is charging.

### BACKGROUND OF THE INVENTION

Typically, mobile device users charge their devices on a desk or other table top surface. This leaves a long wire from the outlet to the device itself which gets in the way and can end up with the device falling to the ground and getting damaged.

U.S. Patent Publication No 2010/0065297 and U.S. Pat. No. 7,812,257 B2 to Gundermann et al., U.S. Patent Publication No. 2011/0132634 to Fetzer-Westmeister and U.S. Pat. No. 7,067,737 to Mallen all disclose outlet cover plates with a shelf, ledge or attachment to hold a mobile device. However, none of these references disclose an outlet cover having a top extension with a hole underneath for charging a mobile device.

Accordingly, there is a need for users to house their mobile devices directly above the wall outlet without having any long wires hanging, thus protecting the device from damage.

The advantage of the invention is to provide a wall dock outlet plate to keep mobile devices and/or computer tablets above the outlet and free from the floor or desk top. The invention organizes the user's wall and floor space to be free from hanging and obstructive wires.

An advantage of the invention is to permit the user to have both outlet ports available while having a holster for a mobile device while charging.

### SUMMARY OF THE INVENTION

In the present invention, these purposes, as well as others which will be apparent, are achieved generally by providing an outlet cover including a face plate 6 with at least one outlet opening to fit over an electrical wall outlet; and a ledge 1 above and perpendicular to the outlet opening. The ledge 1 has an opening 3, such that a mobile device and/or tablet fits securely on the ledge and the charging wire for the device and/or tablet fits through the opening 3 to charge the device and/or tablet without excess wire hanging.

The ledge 1 is preferably flat and at a 90° angle to the face plate 6 to securely hold the mobile device and/or tablet.

The outlet cover further includes a front edge 2 extending in an upward direction from the ledge 1. The front edge 2 that is high enough to hold the mobile device and/or tablet securely in place on the ledge 1.

The outlet cover further includes at least one hole 8 to secure the outlet cover to a wall.

The outlet cover further includes a back plate 11 extending in an upward direction from the ledge 1. The back plate 11 is parallel to the front edge 2 such that the device leans against the back plate 11.

The outlet opening can either be a single outlet opening 13 or a double socket opening 4, 5.

The outlet cover of the invention fits over an electrical wall outlet that is a conventional outlet. In other embodiments the electrical wall outlet is at least one USB port and a conventional outlet. In yet other embodiments the electrical wall outlet is two UB ports.

The outlet cover is preferably made of a plastic material, although other materials that are used for making outlet covers can be used.

In another embodiment the invention includes a wall dock charging station for a mobile device and/or tablet. The charging station is a single unitary structure and includes a face plate 6 with at least one outlet opening to fit over an electrical wall outlet; and a ledge 1 above and perpendicular to the outlet opening, wherein the ledge 1 has an opening 3, such that the mobile device and/or tablet fits securely on the ledge and the charging wire for the device and/or tablet fits through the opening 3 to charge the device and/or tablet.

The ledge 1 in the charging station is preferably at a 90° angle to the face plate 6 and is wide enough to hold the mobile device and/or tablet.

The wall dock charging station further includes a front edge 2 extending in an upward direction from the ledge 1.

The wall dock charging station further includes a front edge 2 that is high enough to hold the mobile device and/or tablet securely in place on the ledge 1 while the device is charging.

The wall dock charging station includes at least one hole 8 in the face plate to secure the charging station to a wall.

The wall dock charging station further includes a back plate 11 extending in an upward direction from the ledge 1. The back plate is parallel to the front edge 2.

As in the first embodiment of the invention, the outlet opening can either be a single outlet opening 13 or a double outlet opening 4, 5.

Conventional outlet covers are 3 inches wide by 5 inches high. The ledge of the invention is preferably 3 inches wide. The front edge is between 0.25 to 1 inch high just enough to hold the device in place. The back plate extends from the ledge at least an inch or more, preferably between 1 to 3 inches.

The outlet cover wall dock is preferably made of plastic and made from a mold so that it is a single integral piece.

Other objects, features and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIG. 1 illustrates the components of the invention for a conventional outlet showing a mobile device charging;

FIG. 2 illustrates a frontal view of the components of the invention for a conventional outlet;

FIG. 3 illustrates a frontal view of the components of the invention for a conventional outlet showing a tablet charging;

FIG. 4 illustrates a side view of the components of the invention for a mixed USB and conventional outlet showing a mobile device charging in a USB port;

FIG. 5 illustrates a frontal view of the components of the invention for a mixed USB and conventional outlet showing a mobile device charging in a USB port; and

FIG. 6 illustrates a frontal view of the components of the invention for a mixed USB and conventional outlet where there are two USB ports on top of each other.

### DETAILED DESCRIPTION OF THE INVENTION

In accordance with the present invention an outlet cover comprising a face plate with at least one outlet opening to fit over an electrical wall outlet and a flat ledge above and perpendicular to the outlet opening having an opening in the ledge for the charging wire to fit through is provided. As described in the accompanying drawings the structures of the invention device are labeled as follows:

1—Ledge to rest the device on;

2—Front Edge to keep the device in place on the ledge;

3—Opening for device charging plug connection;

4—Upper electrical socket opening;

5—Lower electrical socket opening;

6—Face plate with double socket opening;

7—Device;

8—Hole to secure invention to a wall;

9—Device charger plug;

10—Outlet Cover Wall Dock;

11—Back Plate to rest the device against;

12—Face Plate with single socket opening;

13—Single socket opening; and

14—USB charging plug.

The terms socket and outlet are equivalent and are used interchangeably throughout the specification. They allow electrically operated equipment to be connected to primary alternating current (AC) power supply in a home or commercial building. The socket/outlets in the invention include conventional three prong plugs and USB plugs and combinations thereof, for charging mobile devices and tablets.

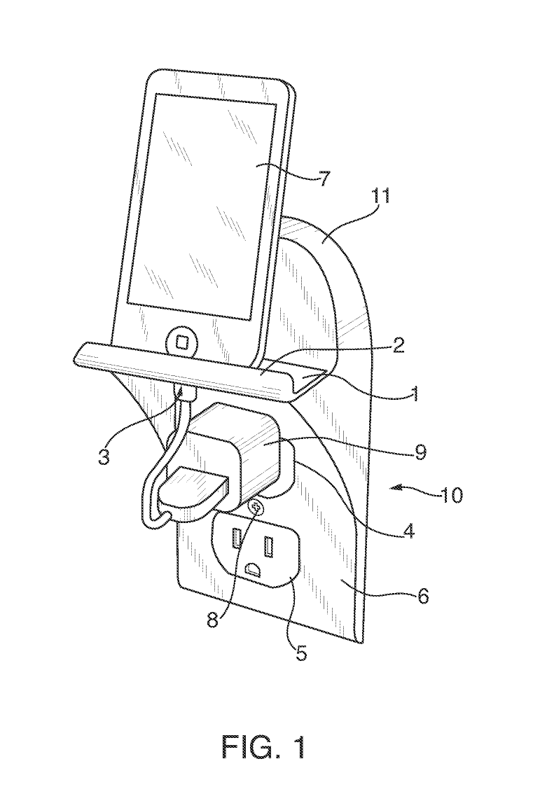

As illustrated in FIG. 1, an outlet cover 10 is shown with a face plate 6 having at least one outlet opening to fit over an electrical wall outlet.

Conventional outlet covers are typically 3 inches wide by 5 inches high. The face plate 6 portion of the invention has conventional outlet cover dimensions.

The outlet cover has a ledge 1 above and perpendicular to the outlet opening. The ledge is used to hold and seat a mobile device and/or tablet while being charged.

The ledge (or seat) is flat and has an opening 3 underneath it to plug a wire through into the device to charge it. The charging wire for the device fits through the opening 3 to charge the device without excess wire hanging.

The ledge 1 is preferably at a 90° angle to the face plate 6 and would typically be at least 3 inches wide.

A front edge 2, or lip, extends in an upward direction of the ledge 1. The front edge 2 is high enough to hold the mobile device and/or tablet securely in place on the flat ledge 1. Preferably the front edge is between 0.25-1 inch high.

There is at least one hole 8 to secure the outlet cover to the wall and to hold in place over the outlet.

A back plate 11 extends in an upward direction from the ledge 1 and is parallel to the front edge 2. The back plate can be square or rounded and extends an inch or more from the ledge 1, preferably between 1-3 inches.

The size of the ledge, front lip and back plate can vary and is dependent on the size of the device. While ranges are provided, other dimensions are also within the scope of the invention.

In an alternate embodiment, there is no back plate and the device being charged leans directly against the wall. The lip (front edge 2) above the outlet cover keeps it stable in its seat (ledge 1).

The outlet opening in FIG. 1 shows a double socket opening 4, 5. The wall outlet is a conventional outlet to charge a three prong power plug 9.

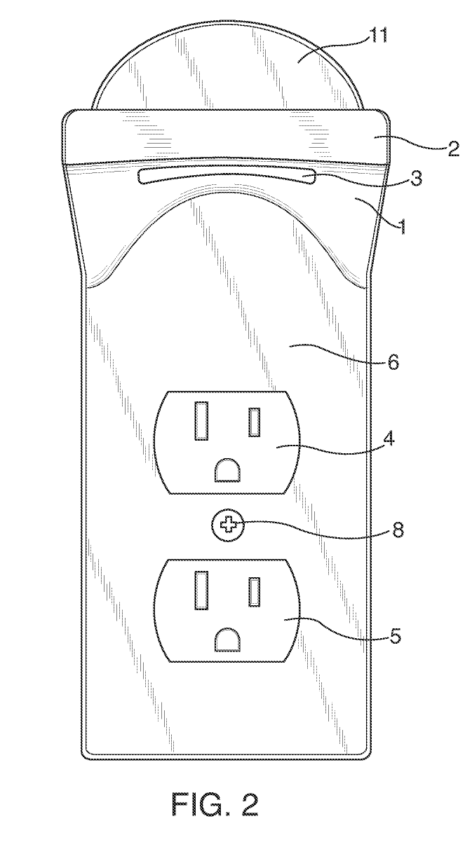

FIG. 2 illustrates a frontal view of the components of the invention for a double socket conventional outlet. The ledge 1 is above the top outlet 4 with an opening 3 underneath for the charging wire to fit thru to plug in to charge the device. The front edge 2, back plate 11 and face plate 6 are also shown.

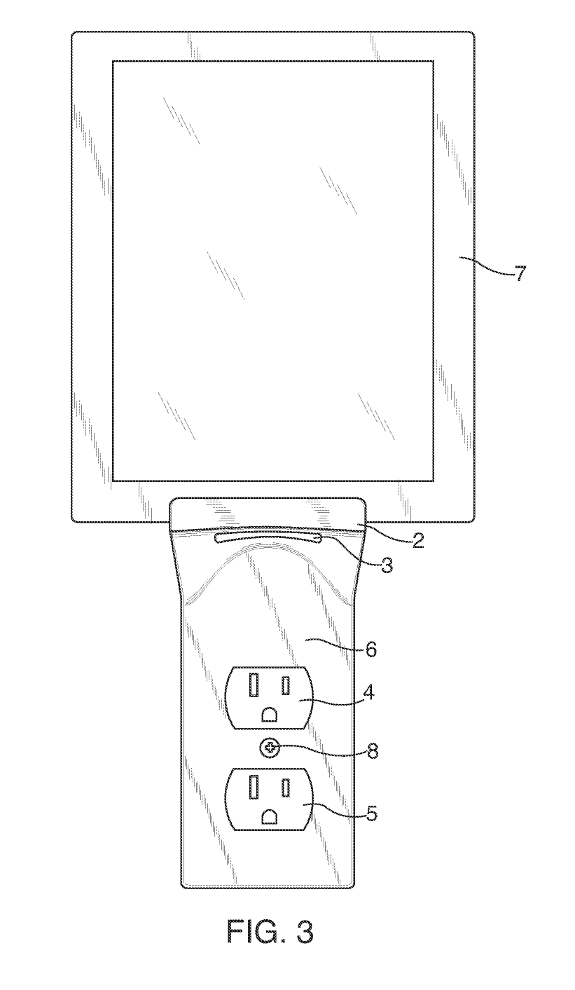

FIG. 3 illustrates a frontal view of the components of the invention for a conventional outlet showing a tablet device 7 resting on the ledge 1 with the front edge 2 keeping the device in place. The illustration shows the tablet securely placed on the ledge and leaning against the wall.

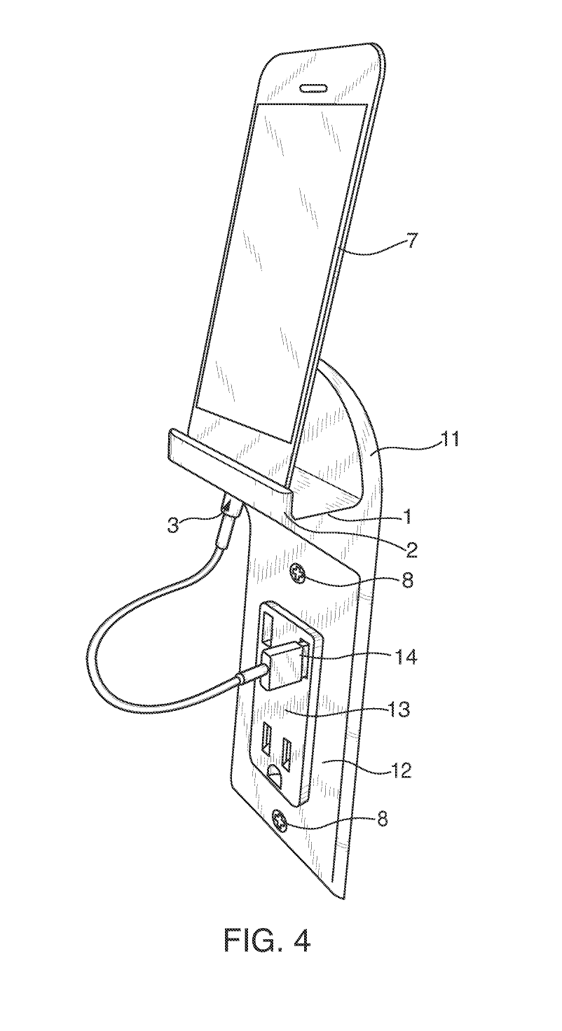

FIG. 4 illustrates a side view of the components of the invention showing a face plate 12 with a single socket opening 13. A mixed USB outlet and conventional three prong outlet 11 is shown. A mobile device is seated on the ledge 1 and resting against the back plate 11 and wall. The device is charging in a USB port with a USB plug 14. There are two USB ports parallel to each other with conventional outlet below. The charging wire fits thru the opening 3 under the ledge 1 to easily plug the device in for charging. There are two holes 8 above and below the single socket opening 13 used to secure the cover in place with screws.

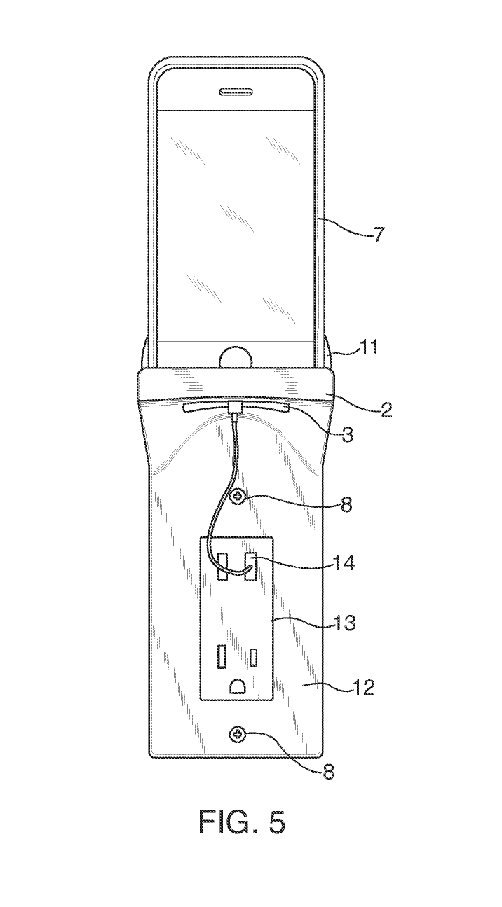

FIG. 5 illustrates a frontal view of the components of the invention as shown in FIG. 4 for a mixed USB and conventional outlet showing a mobile device 7 charging in a USB port using a USB plug 14.

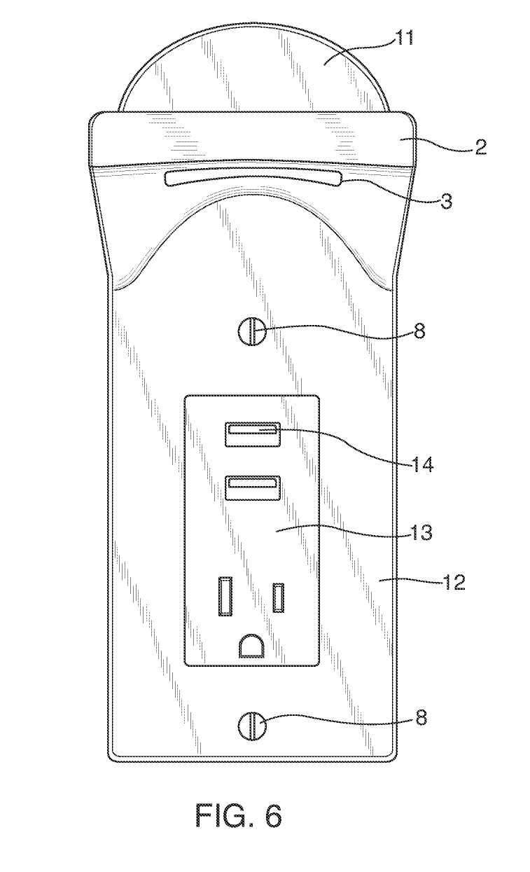

FIG. 6 illustrates a frontal view of the components of the invention as shown in FIG. 4 for a mixed USB and conventional outlet, however, there are two USB ports on top of each other, rather than parallel as in FIG. 4. There is a conventional three prong outlet beneath the two USB ports.

It is within the scope of the invention that conventional plugs and charging devices for the mobile devices and tablets can be used. Shorter charging connectors may also be included so that long wires aren't hanging while the device is charging.

The outlet cover is preferably made of a plastic material, although other non-flammable materials that are used for making outlet covers can be used.

In another embodiment a wall dock charging station for a mobile device and/or tablet comprising a single unitary structure including a face plate 6 with at least one outlet opening to fit over an electrical wall outlet; and a ledge 1 above and perpendicular to the outlet opening is provided.

The ledge 1 has an opening 3, such that the mobile device and/or tablet fits securely on the ledge and the charging wire for the device and/or tablet fits through the opening 3 to charge the device and/or tablet.

The ledge 1 is preferably flat and sits at a 90° angle to the face plate 6. The ledge is wide enough to hold the mobile device and/or tablet.

A front edge 2 extending in an upward direction from the ledge 1 further helps keep the device or tablet in place while charging or just resting. The front edge 2 is high enough to hold the mobile device and/or tablet securely in place on the ledge 1.

At least one hole 8 in the face plate to secure the charging station to a wall with screws.

A back plate 11 maybe present and extends in an upward direction from the ledge 1, wherein said back plate is parallel to the front edge 2.

The outlet opening can be single outlet opening 13 or a double outlet opening 4, 5.

The outlet cover wall dock is preferably made of plastic and made from a mold so that it is a single integral piece.

The invention wall outlet provides an easy way to charge mobile devices and tablet without having any long wires hanging, thus protecting the device from damage. The invention keeps mobile devices and tables above the outlet and free from the floor or desk top.

The invention organizes the user's wall and floor space to be free from hanging and obstructive wires.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. An outlet cover comprising:
a face plate 6 with at least one outlet opening to fit over an electrical wall outlet; and
a ledge 1 above and perpendicular to said outlet opening, wherein said ledge 1 has an opening 3, such that a mobile device and/or tablet fits securely on said ledge and the charging wire for said device and/or tablet fits through said opening 3 to charge the device and/or tablet without excess wire hanging.

2. The outlet cover according to claim 1, wherein said ledge 1 is flat and is at a 90° angle to said face plate 6.

3. The outlet cover according to claim 1, further comprising a front edge 2 extending in an upward direction from said flat ledge 1.

4. The outlet cover according to claim 3, wherein said front edge 2 is high enough to hold the mobile device and/or tablet securely in place on said flat ledge 1.

5. The outlet cover according to claim 1, further comprising at least one hole 8 to secure the outlet cover to a wall.

6. The outlet cover according to claim 3, further comprising a back plate 11 extending in an upward direction from said flat ledge 1, wherein said back plate 11 is parallel to said front edge 2.

7. The outlet cover according to claim 1, wherein said outlet opening is a single outlet opening 13.

8. The outlet cover according to claim 1, wherein said outlet opening is a double socket opening 4, 5.

9. The outlet cover according to claim 1, wherein the electrical wall outlet is a conventional outlet to charge a three prong power plug.

10. The outlet cover according to claim 1, wherein the electrical wall outlet is at least one USB port.

11. The outlet cover according to claim 1, wherein the electrical wall outlet is one conventional outlet and at least one USB port.

12. The outlet cover according to claim 1, wherein the cover is comprised of a plastic material.

13. A wall dock charging station for a mobile device and/or tablet comprising a single unitary structure including a face plate 6 with at least one outlet opening to fit over an electrical wall outlet; and a ledge 1 above and perpendicular to said outlet opening, wherein said ledge 1 has an opening 3, such that the mobile device and/or tablet fits securely on said ledge and the charging wire for the device and/or tablet fits through said opening 3 to charge the device and/or tablet.

14. The wall dock charging station according to claim 13, wherein said ledge 1 is at a 90° angle to said face plate 6 and is wide enough to hold the mobile device and/or tablet.

15. The wall dock charging station according to claim 13, further comprising a front edge 2 extending in an upward direction from said ledge 1.

16. The wall dock charging station according to claim 15, wherein said front edge 2 is high enough to hold the mobile device and/or tablet securely in place on said ledge 1.

17. The wall dock charging station according to claim 13, further comprising at least one hole 8 in said face plate to secure the charging station to a wall.

18. The wall dock charging station according to claim 15, further comprising a back plate 11 extending in an upward direction from said ledge 1, wherein said back plate is parallel to said front edge 2.

19. The wall dock charging station according to claim 13, wherein said outlet opening is a single outlet opening 13.

20. The wall dock charging station according to claim 13, wherein said outlet opening is a double socket opening 4, 5.
